(19) United States
(12) Patent Application Publication
(10) Pub. No.: US 2026/0329693 A1
(43) Pub. Date: Oct. 22, 2026

(54) MEMORY GROUP ALLOCATION USING ADAPTIVE SCAN THRESHOLDS

(71) Applicant: Micron Technology, Inc., Boise, ID (US)

(72) Inventors: Lei Lin, Fremont, CA (US); Guang Hu, Mountain View, CA (US); Dongxiang Liao, Sunnyvale, CA (US); Li-Te Chang, San Jose, CA (US); Zhengang Chen, San Jose, CA (US); Jianmin Huang, Redwood City, CA (US)

(21) Appl. No.: 19/182,181

(22) Filed: Apr. 17, 2025

(51) Int. Cl. G06F 11/10; G06F 9/50

(52) U.S. Cl. CPC G06F 11/1068; G06F 9/5016; G06F 11/1048

(57) ABSTRACT

Methods, systems, and apparatuses include retrieving a failed bit count threshold using a current memory group for a portion of memory. A current offset value is retrieved using the current memory group. A memory group scan is performed on the portion of memory using the current offset value. A current failed bit count is determined using results of the memory group scan. A second offset value is retrieved using a second memory group for the portion of memory. A second memory group scan is performed on the portion of memory using the second offset value. A second failed bit count is determined using results of the second memory group scan. The portion of memory is allocated to a destination memory group using the current failed bit count, the second failed bit count, and the failed bit count threshold.

### TECHNICAL FIELD

The present disclosure generally relates to memory group allocation, and more specifically, relates to memory group allocation using adaptive scan thresholds.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 is a flow diagram of an example method to allocate memory groups using adaptive scan thresholds in accordance with some embodiments of the present disclosure.

FIGS. 3A-3C is a flow diagram of another example method to allocate memory groups using adaptive scan thresholds in accordance with some embodiments of the present disclosure.

FIG. 4 is a flow diagram of another example method to allocate memory groups using adaptive scan thresholds in accordance with some embodiments of the present disclosure.

FIG. 5 is a block diagram of an example computer system in which embodiments of the present disclosure may operate.

### DETAILED DESCRIPTION

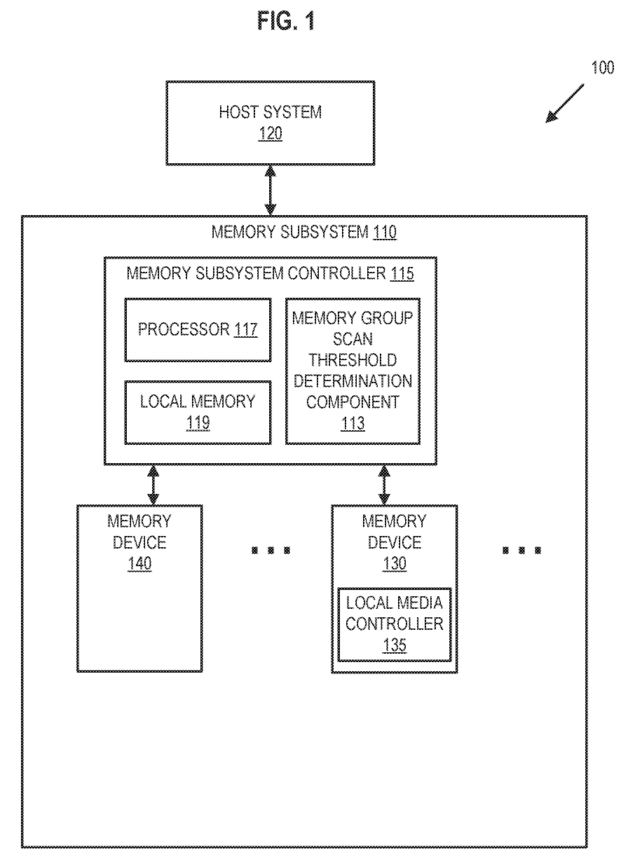

Aspects of the present disclosure are directed to allocate memory groups using adaptive scan thresholds in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1 . The dice in the packages can be assigned to one or more channels for communicating with a memory subsystem controller. Each die can consist of one or more planes. Planes can be grouped into logic units identified by a logical unit number (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information and has various logic states that correlate to the number of bits being stored. The logic states can be represented by binary values, such as "0" and "1", or combinations of such values. There are various types of cells, such as single-level cells (SLCs), multi-level cells (MLCs), triple-level cells (TLCs), quad-level cells (QLCs), and penta-level cells (PLCs). For example, an SLC can store one bit of information and has two logic states while a QLC can store sixteen bits of information and has sixteen logic states.

In conventional memory systems, memory devices include memory portions that have different data retention and reliability characteristics. For example, due to data retention times, environment factors, manufacturing defects, and other variables, the reliability characteristics (e.g., voltage distributions) for some memory portions can vary from other memory portions in the same memory device. These differences in reliability characteristics can be addressed by treating these memory portions differently. For example, memory systems can assign different read levels for different memory groups and allocate memory portions to these memory groups based on their reliability characteristics. These memory systems use memory group scans to determine the reliability characteristics for the memory portion. For example, memory systems perform read operations on the memory portions (or a representative subportion) using read level offsets that differ based on the different potential memory groups. The memory systems assign the memory portion to a memory group associated with the read level offset with the lowest failed bit count. The memory systems can also use the failed bit count results to determine which potential memory group to attempt next. For example, if the failed bit count for a memory group scan is greater than a threshold failed bit count, the memory system can perform another memory group scan using the read level offset for another memory group.

These conventional memory systems use a single failed bit count threshold for all memory groups. The failed bit count characteristics for the memory groups, however, differ between memory groups and over time. For example, the failed bit count for the same memory portion from a memory group scan performed using the same read level offset can differ substantially based on the amount of time the memory portion has been programmed. Additionally, different memory groups have different failed bit count distributions, with non-linear changes in the failed bit count based on the amount of time the data has been retained. Accordingly, conventional memory systems using a single failed bit count threshold can incorrectly allocate memory portions to non-representative memory groups. For example, when using a static failed bit count threshold that is too high, these memory systems can terminate memory group allocation too early and assign the memory portion to a memory group before scanning the optimal memory group. In such an example, because the memory portion is associated with a memory group with a nonoptimal read level offset, read operations performed using this nonoptimal offset result in increased risk for errors. Additionally, because these memory systems use these static failed bit count thresholds to determine subsequent potential memory groups to scan, these systems can end up performing memory group scans for more memory groups than necessary, resulting in large increases in latency and resource consumption. For example, these conventional systems will continue to perform memory group scans for additional memory groups as long as the failed bit counts from the memory group scans are below the failed bit count threshold. When using a static failed bit count threshold that is too high, memory systems can determine that the failed bit count results for each subsequent memory group is still below the failed bit count threshold, resulting in the memory system performing memory group scans for every memory group, resulting in large increases in latency and resource consumption.

Aspects of the present disclosure address the above and other deficiencies by allocating memory groups using adaptive scan thresholds. For example, by associating different memory groups with different failed bit count thresholds, memory systems can more quickly and accurately determine which potential memory groups to use for subsequent memory group scans. These memory systems perform memory group scans using a current memory group to which the memory portion belongs and compare the failed bit count with the failed bit count threshold for that memory group. Based on this comparison, the memory systems can determine whether to allocate a given portion of memory to one of the other memory groups using subsequent memory group scans. These memory systems can compare the results of the subsequent memory group scans (e.g., for the other potential memory groups) to the failed bit count threshold for the current memory group in order to more quickly determine an optimal memory group for the memory portion. Additionally, these memory systems can compare failed bit counts of different memory group scans to select an optimal subsequent memory group. This allows the correct memory group to be determined with fewer memory group scans, improving the efficiency of the system and reducing the latency caused by memory group allocation. Additionally, these memory systems can continuously update the failed bit count thresholds allowing the memory systems to more accurately track the failed bit counts based on the operational lifetime of the memory device (and/or based on environmental factors such as temperature). This also results in decreased latency for memory group scan operations as well as decreased risk nonoptimal memory group allocation. Accordingly, these memory systems have reduced latency and resource consumption as well as a lower chance for errors.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processing device such as a processor chipset and a software stack executed by the processor chipset. The processor chipset can include one or more cores, one or more caches, a memory controller (e.g., NVDIMM controller), and/or a storage protocol controller (e.g., a peripheral component interconnect express (PCIe) controller, a serial advanced technology attachment (SATA) controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a SATA interface, including a mini-SATA (mSATA) interface, a PCIe interface, including a mini PCIe (mPCIE) interface, a Non-Volatile Memory Express (NVMe) interface, a universal serial bus (USB) interface, an a Fibre Channel, Serial Attached SCSI (SAS), a Small Computer System Interface (SCSI), a double data rate (DDR) memory bus, a dual in-line memory module (DIMM) interface (e.g., DIMM socket interface that supports Double Data Rate (DDR)),an Advanced Host Controller (AHCI) interface, an Open NAND Flash Interface (ONFI) interface, a Double Data Rate (DDR) interface, a Low Power Double Data Rate (LPDDR) interface, any other interface, and/or combinations of these interfaces. The physical host interface can be used to transmit data between the host system 120 and the memory subsystem 110. The host system 120 can further utilize an NVMe interface to access components (e.g., memory devices 130 and 140) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via the same communication connection, multiple separate communication connections, and/or a combination of communication connections.

The memory devices 130 and 140 can include any combination of the different types of non-volatile memory devices and/or volatile memory devices. The volatile memory devices (e.g., memory device 140) can be, but are not limited to, random-access memory (RAM), such as dynamic random-access memory (DRAM), synchronous dynamic random-access memory (SDRAM), video random-access memory (VRAM), and cache memory.

Some examples of non-volatile memory devices (e.g., memory device 130) include negative-and (NAND) type flash memory devices and write-in-place type memory devices, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), Spin Transfer Torque (STT)-MRAM, nano-RAM (NRAM), silicon-oxide-nitride-oxide-silicon (SONOS) memory, conductive bridging RAM (CBRAM), resistive random-access memory (RRAM), oxide based RRAM (OxRAM), negative-or (NOR) flash memory, and erasable programmable read-only memory (EPROM), including electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The buffer memory of subsystem controller 115 can include any of the volatile or non-volatile memory types mentioned above including combinations thereof. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in memory subsystem 110 (e.g., stored in a local memory 119). In some examples, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processing device or controller separate from the memory subsystem 110).

In general, the memory subsystem controller 115 can receive commands or operations from the host system 120 and can convert the commands or operations into instructions or appropriate commands to achieve the desired access to the memory devices (e.g., memory devices 130 and/or 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA) and/or namespace) and a physical address (e.g., physical block address) that are associated with the memory devices (e.g., memory devices 130 and/or 140). The memory subsystem controller 115 can further include host interface circuitry to communicate with the host system 120 via the physical host interface. The host interface circuitry can convert the commands received from the host system into command instructions to access the memory devices (e.g., memory devices 130 and/or 140) as well as convert responses associated with the memory devices into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices (e.g., memory devices 130 and/or 140).

In some embodiments, the memory devices (e.g., memory devices 130 and/or 140) include local media controllers 135 that operate in conjunction with memory subsystem controller 115 to execute operations on one or more memory cells of the memory devices (e.g., memory devices 130 and/or 140). An external controller (e.g., memory subsystem controller 115) can externally manage the memory devices (e.g., perform media management operations on the memory devices 130 and/or 140). In some embodiments, a memory device (e.g., memory device 130) is a managed memory device, which is a raw memory device combined with a local controller (e.g., local controller 135) for media management within the same memory device package. An example of a managed memory device is a managed NAND (MNAND) device.

The memory subsystem 110 includes a memory group scan threshold determination component 113 that allocates memory groups using the results of memory group scans performed based on adaptive scan thresholds. In some embodiments, the controller 115 includes at least a portion of the memory group scan threshold determination component 113. For example, the controller 115 can include a processing device 117 configured to execute instructions stored in local memory 119 for performing the operations described herein. In some embodiments, a memory group scan threshold determination component 113 is part of the host system 120, an application, or an operating system.

The memory group scan threshold determination component 113 compares a memory group scan threshold for a current memory group of a portion of memory to the results of memory group scans for other memory groups to determine a memory group allocation for the memory portion. Further details with regards to the operations of the memory group scan threshold determination component 113 are described below.

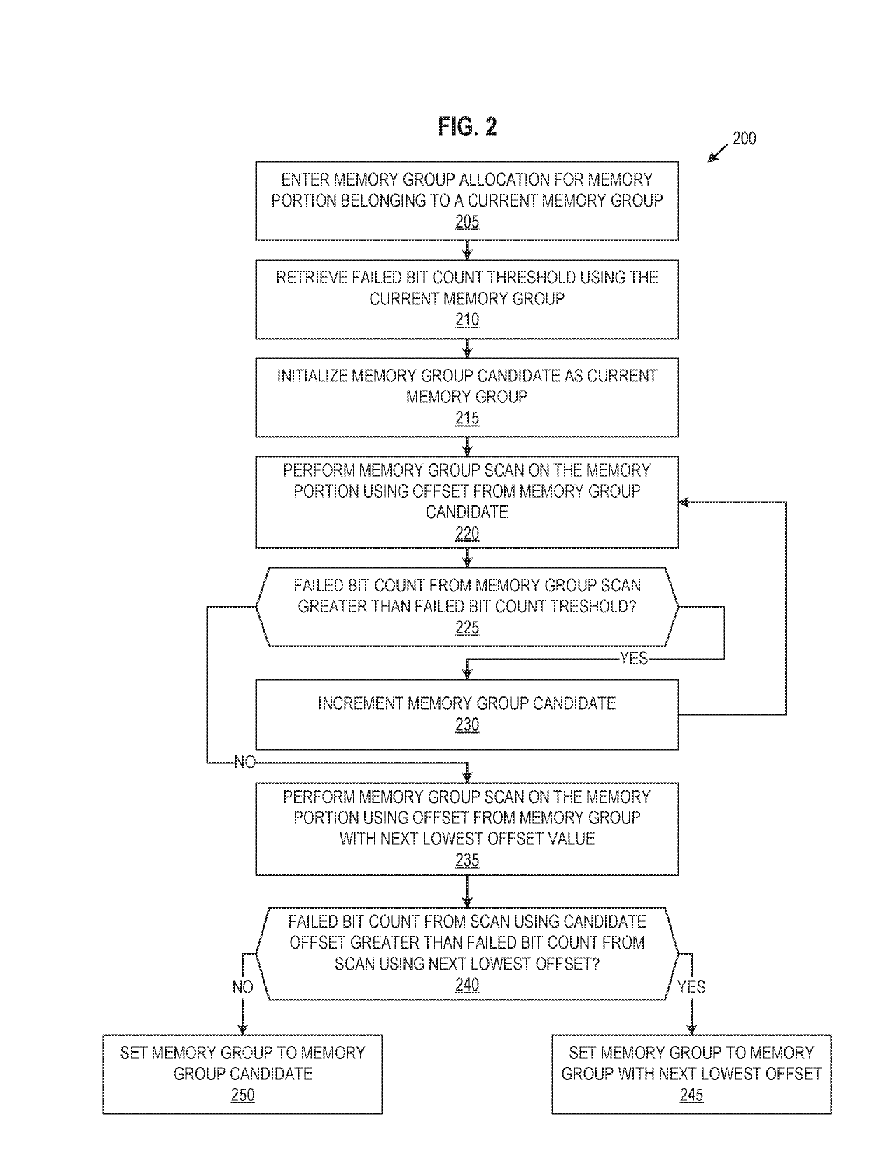

FIG. 2 is a flow diagram of an example method 200 to allocate memory groups using adaptive scan thresholds, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the memory group scan threshold determination component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 205, the processing device enters memory group allocation for a memory portion belonging to a current memory group. For example, memory group scan threshold determination component 113 determines that the read count for a memory block of memory device 130 is greater than a read count threshold and enters memory group allocation for that memory block. In the context of this application, a memory group refers to groups of memory portions that use the same read level offset values. For example, during memory read operations, memory group scan threshold determination component 113 uses a memory group for a portion of memory targeted by the memory operation to determine a read voltage offset value to use when performing the read operation on the memory portion.

In some embodiments, memory group scan threshold determination component 113 allocates memory groups for portions of memory based on estimations for the characteristics of memory cells in that portion of memory. For example, memory group scan threshold determination component 113 allocates memory portions to a memory group such that the memory portions in that memory group maintain consistent behavior throughout their lifespan. As the age of the data stored in these memory portions increases, the voltage characteristics of the memory cells in the memory portions shift, resulting in voltage distributions that are offset from the voltage distributions at the time of programming. Similarly, the environmental conditions of the memory portions and/or memory device can also contribute to the shifted voltage distributions. For example, higher temperatures can result in a greater shift in the voltage distributions. Accordingly, memory group scan threshold determination component 113 allocates memory groups for memory portions that are programmed within a similar time or temperature window. When performing read operations on a memory portion, memory group scan threshold determination component 113 uses a read voltage based on the memory group to which that memory portion belongs, thereby accounting for estimated voltage shifts and reducing the likelihood of errors.

In some embodiments, memory group scan threshold determination component 113 enters memory group allocation for a memory block based on a time since a previous memory group scan. For example, memory group scan threshold determination component 113 performs memory group allocation at set time intervals. In some embodiments, memory group scan threshold determination component 113 determines the time interval for memory group allocation based on the current memory group. For example, memory group scan threshold determination component 113 uses shorter time intervals (e.g., every 20 minutes) for memory groups associated with less estimated change in voltage distribution and therefore smaller read level offsets (e.g., memory groups that have been more recently programmed and/or programmed under lower temperature conditions) and longer time intervals (e.g., every hour) for memory groups associated with more estimated change in voltage distribution and therefore larger read level offsets (e.g., memory groups that have been less recently programmed and/or programmed under higher temperature conditions). . . While described referencing data retention time and temperatures, memory group scan threshold determination component 113 can allocate memory groups based on various other characteristics as well. For example, memory group scan threshold determination component 113 can allocate memory groups based on known manufacturing defects for physical portions of the memory device.

In some embodiments, memory group scan threshold determination component 113 enters memory group allocation for a memory block based on environmental conditions for that memory block. For example, memory group scan threshold determination component 113 enters memory group allocation for a memory block in response to the temperature for the memory block satisfying a temperature threshold. For example, memory group scan threshold determination component 113 enters memory group allocation for a memory block in response to the temperature for the memory block exceeding a temperature threshold or in response to the temperature for the memory block falling below a temperature threshold.

In some embodiments, memory group scan threshold determination component 113 enters memory group allocation using a combination of the above methods. For example, memory group scan threshold determination component 113 enters memory group allocation for a memory block based on the historical temperatures for that memory block (and/or for the memory device a whole) and based on the read count or similar metric (e.g., program erase cycles) for that memory block.

At operation 210, the processing device retrieves a failed bit count threshold using the current memory group. For example, memory group scan threshold determination component 113 retrieves a failed bit count threshold based on the current memory group for the memory portion. In some embodiments, memory group scan threshold determination component 113 retrieves the failed bit count threshold using a lookup table. For example, memory group scan threshold determination component 113 retrieves a lookup table from local memory (e.g., local memory 119 of FIG. 1) including memory groups and associated failed bit count thresholds. In such an example, memory group scan threshold determination component 113 uses the lookup table and retrieves the associated failed bit count threshold for the current memory group for the memory portion.

In some embodiments, the failed bit count characteristics for memory groups have a parabolic or other non-linear distribution over data retention time. Accordingly, for each memory group, there is a minimum failed bit count for that memory group associated with a certain data retention time. In such embodiments, memory group scan threshold determination component 113 can include a look-up table with a failed bit count threshold for each memory group based on the minimum estimated failed bit count for that memory group. In one example, memory group scan threshold determination component 113 includes a look-up table with a failed bit count threshold for each memory group that is slightly lower than the expected minimum failed bit count based on the failed bit count characteristics for that memory group. In general, as older memory groups (i.e., groups of memory with more time after programming relative to other groups of memory) are associated with larger distribution shifts, older memory groups also have higher failed bit count thresholds than younger memory groups (i.e., groups of memory with less time after programming relative to other groups of memory).

In some embodiments, memory group scan threshold determination component 113 updates the failed bit count thresholds based on environmental conditions. For example, memory group scan threshold determination component 113 updates the failed bit count thresholds based on temperatures for the memory device and/or memory portions in the memory groups. For example, memory group scan threshold determination component 113 can, updates the failed bit count threshold for a memory group based on a determination of whether the temperature for the memory group (and/or temperature over a given period of time) satisfies a temperature threshold. In one example, memory group scan threshold determination component 113 increases the failed bit count threshold for a memory group in response to determining that the temperature (and/or temperature over given period of time) for that memory group and/or the memory device exceeds the threshold. In another example, memory group scan threshold determination component 113 decreases the failed bit count threshold for a memory group in response to determining that the temperature (and/or temperature over given period of time) for that memory group and/or the memory device is less than the threshold.

At operation 215, the processing device initializes a memory group candidate as current memory group. For example, memory group scan threshold determination component 113 sets the current memory group as a memory group candidate for memory group allocation. The memory group candidate refers to a potential memory group to which memory group scan threshold determination component 113 can assign the memory portion. In some embodiments, memory group scan threshold determination component 113 retrieves an offset value for the current memory group to use for a memory group scan. For example, memory group scan threshold determination component 113 retrieves a read voltage offset value from a look-up table for the current memory group.

At operation 220, the processing device performs a memory group scan on the memory portion using a read offset from the memory group candidate. For example, memory group scan threshold determination component 113 performs a scan at a read voltage determined using the read voltage offset value retrieved for the current memory group. In some embodiments, memory group scan threshold determination component 113 performs the memory group scan by applying a read voltage determined based on the offset value and determining a failed bit count as a number of memory cells in the memory portion with voltages higher than the offset value. For example, memory group scan threshold determination component 113 determines a read voltage as a standard read voltage minus the offset value.

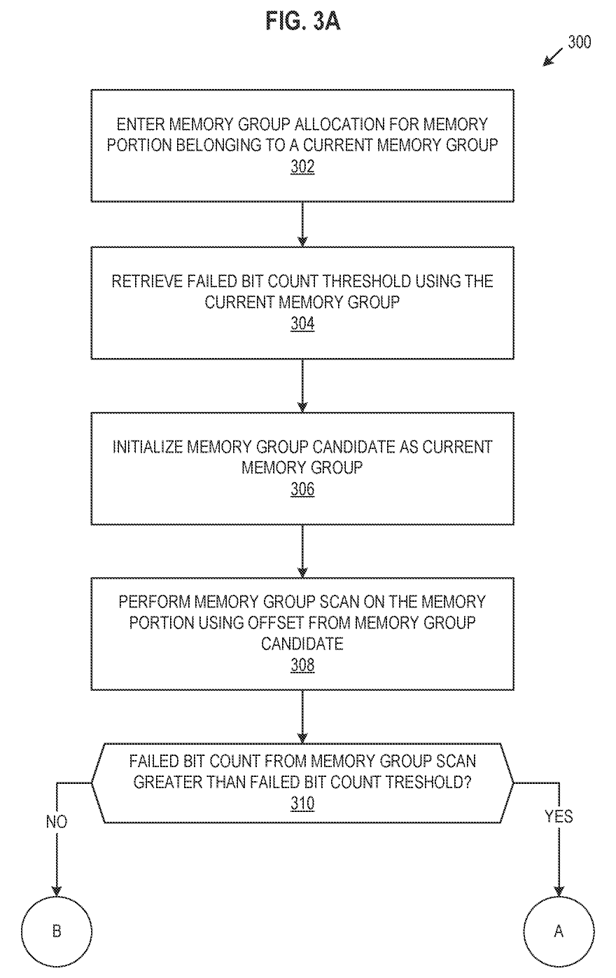

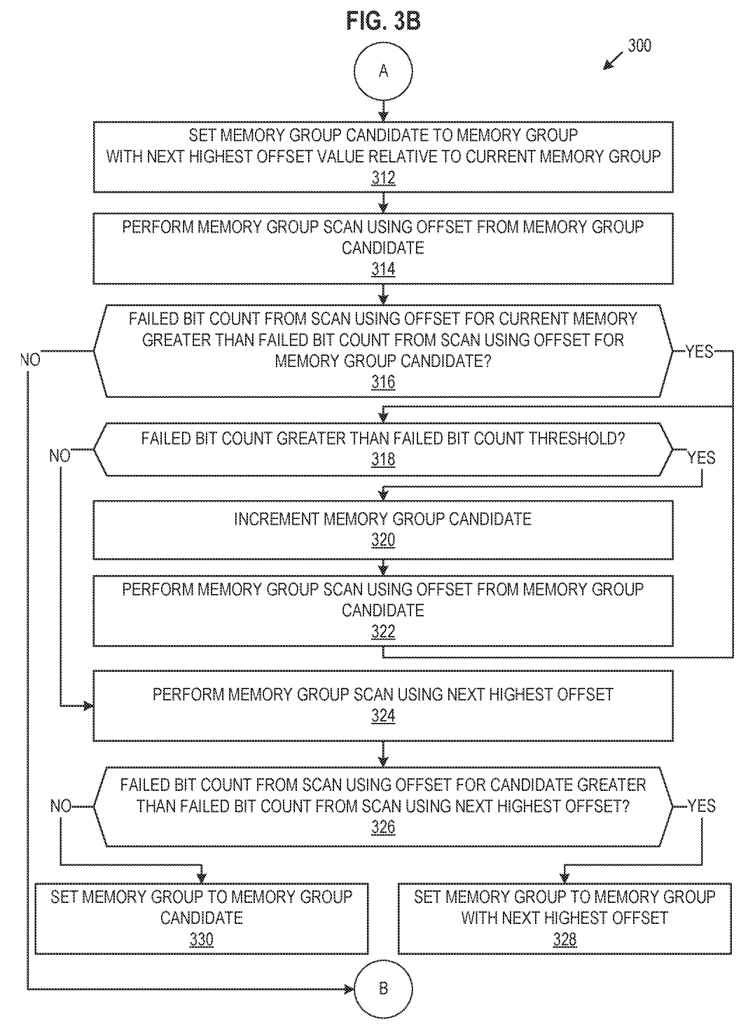

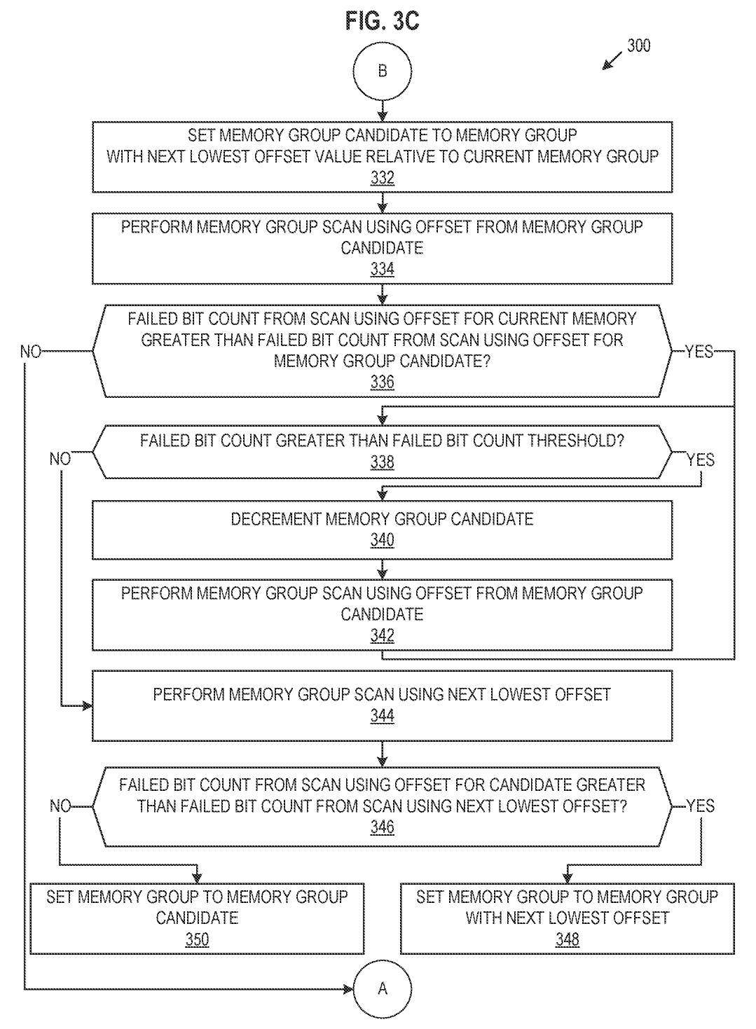

At operation 225, the processing device determines whether the failed bit count from the memory group scan satisfies (e.g., is greater than) the failed bit count threshold. For example, memory group scan threshold determination component 113 determines whether the failed bit count (e.g., number of memory cells above the read voltage for the memory group scan) exceeds the failed bit count threshold for the current memory group. If the processing device determines that the failed bit count from the memory group scan is greater than the failed bit count threshold, the method 200 proceeds to operation 230, increments the memory group candidate, and performs a scan on the memory portion using an offset from the incremented memory group candidate. For example, as long as the failed bit count from the memory group scan is greater than the failed bit count threshold, the processing device continues to perform memory group scans using increasingly larger offsets (e.g., from older memory groups). In some embodiments, as discussed with refence to FIGS. 3A-3C, the processing device determines whether the failed bit count from subsequent scans is increasing or decreasing to determine a subsequent memory group. If the processing device determines that the failed bit count from the memory group scan is not greater than the failed bit count threshold, the method 200 proceeds to operation 235.

At operation 230, the processing device increments the memory group candidate. For example, memory group scan threshold determination component 113 increments the memory group candidate to the memory group with the next highest offset value (e.g., the next oldest memory group), retrieves a look-up table from local memory (e.g., local memory 119), and determines an offset value using the incremented memory group candidate. The processing device uses this offset value to perform a memory group scan on the memory portion.

In some embodiments, in response to determining that the current memory group candidate is the oldest memory group candidate (e.g., determining that the offset value for the memory group is the largest offset value), memory group scan threshold determination component 113 resets the memory group candidate to a default value (e.g., the memory group with the lowest offset value). In such embodiments, if the processing device determines that the failed bit counts for the memory group scans using offsets for every memory group all exceed the failed bit count threshold, the processing device sets the memory group for the memory portion as the memory group associated with the lowest failed bit count of all the memory group scans.

At operation 235, the processing device performs a memory group scan on the memory portion using an offset from the memory group with the next lowest offset value (e.g., the memory group one younger than the memory group candidate). For example, in response to determining that the failed bit count for the memory group candidate is lower than the threshold, memory group scan threshold determination component 113 performs a memory group scan on the memory portion using the offset from the memory group that is one younger than the memory group candidate. In some embodiments, the processing device skips this step if the processing device has already recently performed the memory group scan using the offset from the memory group below the memory group candidate and/or if the results from the recent memory group scan using the offset are still in memory (e.g., local memory 119). For example, if memory group scan threshold determination component 113 has already performed the memory group scan using the memory group below the memory group candidate, memory group scan threshold determination component 113 retrieves the results from that memory group scan from memory and proceeds to operation 240.

At operation 240, the processing device determines whether the failed bit count from the memory group scan using the offset for the memory group candidate is greater than the failed bit count from the memory group scan using the offset for the memory group below the memory group candidate. For example, memory group scan threshold determination component 113 compares the results of the previous two memory group scans and determines which failed bit count is greater. If the processing device determines that the failed bit count from the memory group scan using the offset for the memory group candidate is greater than the failed bit count from the memory group scan using the offset from the memory group below the memory group candidate, the method 200 proceeds to operation 245. If the processing device determines that the failed bit count from the memory group scan using the offset for the memory group candidate is not greater than the failed bit count from the memory group scan using the offset from the memory group with the next lowest offset value, the method 200 proceeds to operation 250.

At operation 245, the processing device sets the memory group for the memory portion to the memory group with the next lowest offset value. For example, memory group scan threshold determination component 113 determines that the failed bit count for the memory group candidate is greater than the failed bit count for the memory group with the next lowest offset value and therefore selects the memory group with the next lowest offset value as the optimal memory group for the memory portion. In some embodiments, the processing device sets the memory group for the memory portion as the memory group with the next lowest offset value by updating a look-up table.

At operation 250, the processing device sets the memory group for the memory portion to the memory group candidate. For example, memory group scan threshold determination component 113 determines that the failed bit count for the memory group candidate is not greater than the failed bit count for the memory group with the next lowest offset value and therefore selects the memory group candidate as the optimal memory group for the memory portion. In some embodiments, the processing device sets the memory group for the memory portion as the memory group candidate by updating a look-up table.

FIGS. 3A-3C is a flow diagram of an example method 300 to allocate memory groups using adaptive scan thresholds, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the memory group scan threshold determination component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 302, the processing device enters memory group allocation for a memory portion belonging to a current memory group. For example, memory group scan threshold determination component 113 determines that the read count for a memory block of memory device 130 is greater than a read count threshold and enters memory group allocation for that memory block. Further details regarding entering memory group allocation for a memory portion belonging to a current memory group are discussed with reference to FIG. 2.

At operation 304, the processing device retrieves a failed bit count threshold using the current memory group. For example, memory group scan threshold determination component 113 retrieves a failed bit count threshold based on the current memory group for the memory portion. Further details regarding retrieving a failed bit count threshold using the current memory group are discussed with reference to FIG. 2.

At operation 306, the processing device initializes the memory group candidate as the current memory group. For example, memory group scan threshold determination component 113 sets the current memory group as a memory group candidate for memory group allocation. Further details regarding initializing the memory group candidate as the current memory group are discussed with reference to FIG. 2.

At operation 308, the processing device performs a memory group scan on the memory portion using an offset from the memory group candidate. For example, memory group scan threshold determination component 113 performs a scan at a read voltage determined using the read voltage offset value retrieved for the current memory group. Further details regarding performing a memory group scan on the memory portion using an offset from the memory group candidate are discussed with reference to FIG. 2.

At operation 310, the processing device determines whether the failed bit count from the memory group scan is greater than the failed bit count threshold. For example, memory group scan threshold determination component 113 determines whether the failed bit count (e.g., number of memory cells above the read voltage for the most recent memory group scan) exceeds the failed bit count threshold for the current memory group. If the processing device determines that the failed bit count from the memory group scan is greater than the failed bit count threshold, the method 300 proceeds to operation 312 of FIG. 3B and increments the memory group candidate to the memory group with the next highest offset value. If the processing device determines that the failed bit count from the memory group scan is not greater than the failed bit count threshold, the method 300 proceeds to operation 332 of FIG. 3C and decrements the memory group candidate to the memory group with the next lowest offset value. Further details regarding determining whether the failed bit count from the memory group scan is greater than the failed bit count threshold are discussed with reference to FIG. 2.

At operation 312, the processing device sets the memory group candidate as the memory group with the next highest offset value. For example, memory group scan threshold determination component 113 sets the memory group candidate for the memory portion to the memory group with the next highest offset value relative to the current memory group to which the memory portion is assigned. If proceeding from operation 310 from FIG. 3A, the processing device can, for example, increment the memory group candidate. If proceeding from operation 336 of FIG. 3C, the processing device can set the memory group candidate as the memory group that has an offset value that is the next highest offset value relative to the offset value for the current memory group. This ensures that the processing device is proceeding in the correct direction from the current memory group. For example, as discussed in further detail below, if the processing device determines that the failed bit count from memory scans using offsets from subsequent memory groups is increasing (e.g., failed bit count increases as the offset value decreases), the processing device can set the memory group candidate to the memory group with the next highest offset value instead of having to continue decrementing the offset value. In some embodiments, the processing device retrieves an offset value for the memory group with the next highest offset value. For example, memory group scan threshold determination component 113 retrieves an offset value from local memory (e.g., local memory 119) using the next oldest memory group.

At operation 314, the processing device performs a memory group scan using an offset from the memory group candidate. For example, memory group scan threshold determination component 113 performs a scan at a read voltage determined using the read voltage offset value retrieved for the memory group candidate (e.g., memory group with the next highest offset value relative to the current memory group) and determines a failed bit count for the memory group scan as the number of cells above the read voltage. Further details regarding performing a memory group scan on the memory portion using an offset from the memory group candidate are discussed with reference to FIG. 2.

At operation 316, the processing device determines whether the failed bit count from the memory group scan using the offset for the current candidate memory group is greater than the failed bit count from the memory group scan using the offset for the memory group candidate. For example, memory group scan threshold determination component 113 compares the results of the memory group scans for the current memory group to which the memory portion is assigned and the memory group with the next highest offset value relative to the current memory group. Accordingly, memory group scan threshold determination component 113 can determine whether the failed bit count is increasing or decreasing as a result of the offset value increase. This allows the processing device to switch the direction of offset value changes between subsequent memory groups (e.g., from memory groups with higher offset values than the current memory group to memory groups with lower offset values than the current memory group) in response to determining that the failed bit count is increasing. If the processing device determines that the failed bit count from the memory group scan using the offset for the current memory group is greater than the failed bit count from the memory group scan using the offset for the memory group candidate (e.g., failed bit count is decreasing as the offset value is increasing), the method 300 proceeds to operation 318. If the processing device determines that the failed bit count from the memory group scan using the offset for the current memory group is not greater than the failed bit count from the memory group scan using the offset for the memory group candidate (e.g., failed bit count is increasing as the offset value is increasing), the method 300 proceeds to operation 332 of FIG. 3C and the processing device sets the memory group candidate to the memory group with the next lowest offset value relative to the current memory group.

At operation 318, the processing device determines whether the failed bit count from the memory group scan for the memory group candidate is greater than the failed bit count threshold. For example, memory group scan threshold determination component 113 determines whether the failed bit count (e.g., number of memory cells above the read voltage for the most recent memory group scan) exceeds the failed bit count threshold for the current memory group. If the processing device determines that the failed bit count from the memory group scan for the memory group candidate is greater than the failed bit count threshold, the method 300 proceeds to operation 320. If the processing device determines that the failed bit count from the memory group scan for the memory group candidate is not greater than the failed bit count threshold, the method 300 proceeds to operation 324. For example, memory group scan threshold determination component 113 has found a memory group with a failed bit count below the threshold and will attempt to perform another memory group scan before assigning the memory group. Further details regarding determining whether the failed bit count from the memory group scan for the memory group candidate is greater than the failed bit count threshold are discussed with reference to FIG. 2.

At operation 320, the processing device increments the memory group candidate. For example, memory group scan threshold determination component 113 increments the memory group candidate to the memory group with the next highest offset value, retrieves a look-up table from local memory (e.g., local memory 119), and determines an offset value using the incremented memory group candidate. The processing device uses this offset value to perform a memory group scan on the memory portion. In some embodiments, in response to determining that the current memory group candidate has the highest offset value (e.g., determining that the memory group candidate satisfies a candidate threshold), the processing device proceeds to operation 332 of FIG. 3C and sets the memory group candidate to the memory group with the next lowest offset value relative to the current memory group. Further details regarding incrementing the memory group candidate are discussed with reference to FIG. 2.

At operation 322, the processing device performs a memory group scan using an offset from the memory group candidate. For example, memory group scan threshold determination component 113 performs a scan at a read voltage determined using the read voltage offset value retrieved for the memory group candidate and determines a failed bit count for the memory group scan as the number of cells above the read voltage. Further details regarding performing a memory group scan on the memory portion using an offset from the memory group candidate are discussed with reference to FIG. 2.

At operation 324, the processing device performs a memory group scan using the next highest offset. For example, in response to determining that the failed bit count for the memory group candidate is lower than the threshold, memory group scan threshold determination component 113 performs a memory group scan on the memory portion using the offset from the memory group with the next highest offset value relative to the memory group candidate. In some embodiments, the processing device skips this step if the processing device has already recently performed the memory group scan using the offset from the memory group with the next highest offset value and/or if the results from the recent memory group scan are still in memory (e.g., local memory 119). For example, if memory group scan threshold determination component 113 has already performed the memory group scan using the memory group with the next highest offset value, memory group scan threshold determination component 113 retrieves the results from that memory group scan from memory and proceeds to operation 326.

At operation 326, the processing device determines whether the failed bit count from the memory group scan using the offset for the memory group candidate is greater than the failed bit count from the memory group scan using the next highest offset. For example, memory group scan threshold determination component 113 compares the results of the previous two memory group scans and determines which failed bit count is higher. If the processing device determines that the failed bit count from the memory group scan using the offset for the memory group candidate is greater than the failed bit count from the memory group scan using the offset from the memory group with the next highest offset value, the method 300 proceeds to operation 328. If the processing device determines that the failed bit count from the memory group scan using the offset for the memory group candidate is not greater than the failed bit count from the memory group scan using the offset from the memory group with the next highest offset value, the method 300 proceeds to operation 330.

At operation 328, the processing device sets the memory group for the memory portion to the memory group with the next highest offset value. The processing device therefore selects the memory group with the next highest offset value as the optimal memory group for the memory portion. In some embodiments, the processing device sets the memory group for the memory portion as the memory group with the next highest offset value by updating a look-up table. In some embodiments, the memory group with the next highest offset value has a different failed bit count threshold than the current memory group.

At operation 330, the processing device sets the memory group for the memory portion to the memory group candidate. For example, memory group scan threshold determination component 113 determines that the failed bit count for the memory group candidate is not greater than the failed bit count for the memory group with the next highest offset value and therefore selects the memory group candidate as the optimal memory group for the memory portion. In some embodiments, the processing device sets the memory group for the memory portion as the memory group candidate by updating a look-up table.

At operation 332, the processing device sets the memory group candidate as the memory group with the next lowest offset value. For example, memory group scan threshold determination component 113 sets the memory group candidate for the memory portion to the memory group with the next lowest offset value relative to the current memory group to which the memory portion is assigned. If proceeding from operation 310 from FIG. 3A, the processing device can, for example, decrement the memory group candidate. If proceeding from operation 316 of FIG. 3B, the processing device can set the memory group candidate as the memory group with an offset value that is the next lowest relative to the offset value for the current memory group. This ensures that the processing device is proceeding in the correct direction from the current memory group. For example, as discussed above, if the processing device determines that the failed bit count from memory scans using offsets from subsequent memory groups is increasing (e.g., failed bit count increases as offset value increases), the processing device can set the memory group candidate to the memory group with the next lowest offset value instead. In some embodiments, the processing device retrieves an offset value for the memory group with the next lowest offset value. For example, memory group scan threshold determination component 113 retrieves an offset value from local memory (e.g., local memory 119) using the next youngest memory group.

At operation 334, the processing device performs a memory group scan using an offset from the memory group candidate. For example, memory group scan threshold determination component 113 retrieves an offset value using the memory group candidate (e.g., memory group with the next lowest offset value relative to the current memory group) and performs a scan at a read voltage determined using the read voltage offset value. In some embodiments, memory group scan threshold determination component 113 performs the memory group scan by applying a read voltage determined using the offset value and determining a failed bit count as a number of memory cells in the memory portion with voltages higher than the offset value. For example, memory group scan threshold determination component 113 determines a read voltage as a standard read voltage minus the offset value and uses the resulting read voltage for the memory group scan. Further details regarding performing a memory group scan using an offset from the memory group candidate are discussed with reference to FIG. 2.

At operation 336, the processing device determines whether the failed bit count from the memory group scan using the offset for the current memory group is greater than the failed bit count from the memory group scan using the offset for the memory group candidate. For example, memory group scan threshold determination component 113 compares the results of the memory group scans for the current memory group and the memory group with the next lowest offset value relative to the current memory group. Accordingly, memory group scan threshold determination component 113 can determine whether the failed bit count is increasing or decreasing as a result of the offset value decreases. This allows the processing device to switch the direction of offset value changes between subsequent memory groups (e.g., from memory groups with higher offset values than the current memory group to memory groups with lower offset values than the current memory group) in response to determining that the failed bit count is increasing. If the processing device determines that the failed bit count from the memory group scan using the offset for the current memory group is greater than the failed bit count from the memory group scan using the offset for the memory group candidate (e.g., failed bit count is decreasing as the offset value is decreasing), the method 300 proceeds to operation 338. If the processing device determines that the failed bit count from the memory group scan using the offset for the current memory group is not greater than the failed bit count from the memory group scan using the offset for the memory group candidate (e.g., failed bit count is increasing as the offset value is decreasing), the method 300 proceeds to operation 312 of FIG. 3B and the processing device sets the memory group candidate to the memory group with the next lowest offset value relative to the current memory group.

At operation 338, the processing device determines whether the failed bit count from the memory group scan for the memory group candidate is greater than the failed bit count threshold. For example, memory group scan threshold determination component 113 determines whether the failed bit count (e.g., number of memory cells above the read voltage for the most recent memory group scan) exceeds the failed bit count threshold for the current memory group. If the processing device determines that the failed bit count from the memory group scan for the memory group candidate is greater than the failed bit count threshold, the method 300 proceeds to operation 340. If the processing device determines that the failed bit count from the memory group scan for the memory group candidate is not greater than the failed bit count threshold, the method 300 proceeds to operation 344. For example, memory group scan threshold determination component 113 has found a memory group with a failed bit count below the threshold and will attempt to perform another memory group scan before assigning the memory group. Further details regarding determining whether the failed bit count from the memory group scan for the memory group candidate is greater than the failed bit count threshold are discussed with reference to FIG. 2.

At operation 340, the processing device decrements the memory group candidate. For example, memory group scan threshold determination component 113 decrements the memory group candidate to the memory group with the next lowest offset value, retrieves a look-up table from local memory (e.g., local memory 119), and determines an offset value using the decremented memory group candidate. The processing device then uses this offset value to perform a memory group scan on the memory portion. In some embodiments, in response to determining that the current memory group candidate has the lowest offset value (e.g., determining that the memory group candidate satisfies a threshold), the processing device proceeds to operation 312 of FIG. 3B and sets the memory group candidate to the memory group with the next highest offset value relative to the current memory group.

At operation 342, the processing device performs a memory group scan using an offset from the memory group candidate. For example, memory group scan threshold determination component 113 performs a scan at a read voltage determined using the read voltage offset value retrieved for the memory group candidate and determines a failed bit count for the memory group scan as the number of cells above the read voltage. Further details regarding performing a memory group scan on the memory portion using an offset from the memory group candidate are discussed with reference to FIG. 2.

At operation 344, the processing device performs a memory group scan using a next lowest offset. For example, in response to determining that the failed bit count for the memory group candidate is lower than the threshold, memory group scan threshold determination component 113 performs a memory group scan on the memory portion using the offset value from the memory groupwith the next lowest offset value relative to the memory group candidate. In some embodiments, the processing device skips this step if the processing device has already recently performed the memory group scan using the offset from the memory group with the next lowest offset value and/or if the results from the recent memory group scan are still in memory (e.g., local memory 119). For example, if memory group scan threshold determination component 113 has already performed the memory group scan using the memory group with the next lowest offset value, memory group scan threshold determination component 113 retrieves the results from that memory group scan from memory and proceeds to operation 346.

At operation 346, the processing device determines whether the failed bit count from the memory group scan using the offset for the memory group candidate is greater than the failed bit count from the memory group scan using the next lowest offset value. For example, memory group scan threshold determination component 113 compares the results of the previous two memory group scans and determines which failed bit count is higher. If the processing device determines that the failed bit count from the memory group scan using the offset for the memory group candidate is greater than the failed bit count from the memory group scan using the offset from the memory group with the next lowest offset value, the method 300 proceeds to operation 348. If the processing device determines that the failed bit count from the memory group scan using the offset for the memory group candidate is not greater than the failed bit count from the memory group scan using the offset from the memory group with the next lowest offset value, the method 300 proceeds to operation 350.

At operation 348, the processing device sets the memory group for the memory portion to the memory group with the next lowest offset value. The processing device therefore selects the memory group with the next lowest offset value as the optimal memory group for the memory portion. In some embodiments, the processing device sets the memory group for the memory portion as the memory group with the next lowest offset value by updating a look-up table. In some embodiments, the memory group with the next lowest offset value has a different failed bit count threshold than the current memory group.

At operation 350, the processing device sets the memory group for the memory portion to the memory group candidate. For example, memory group scan threshold determination component 113 determines that the failed bit count for the memory group candidate is not greater than the failed bit count for the memory group with the next lowest offset value and therefore selects the memory group candidate as the optimal memory group for the memory portion. In some embodiments, the processing device sets the memory group for the memory portion as the memory group candidate by updating a look-up table.

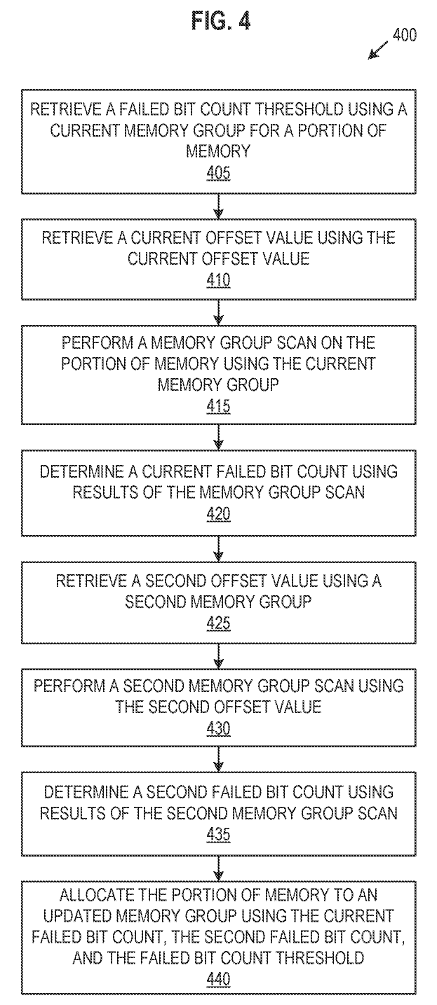

FIG. 4 is a flow diagram of an example method 400 to allocate memory groups using adaptive scan thresholds, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the memory group scan threshold determination component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device retrieves a failed bit count threshold using a current memory group for a portion of memory. For example, memory group scan threshold determination component 113 retrieves a failed bit count threshold for a current memory group for a memory portion from local memory (e.g., local memory 119 of FIG. 1). Further details regarding retrieving a failed bit count threshold using a current memory group for a portion of memory are discussed with reference to FIGS. 2 and 3A-3C.

At operation 410, the processing device retrieves a current offset value using the current memory group. For example, memory group scan threshold determination component 113 retrieves a read voltage offset value for the current memory group using a look-up table. Further details regarding retrieving a current offset value using the current memory group are discussed with reference to FIGS. 2 and 3A-3C.

At operation 415, the processing device performs a memory group scan on the portion of memory using the current offset value. For example, memory group scan threshold determination component 113 performs a scan at a read voltage determined using the current offset value retrieved for the current memory group. Further details regarding performing a memory group scan on the portion of memory using the current memory group are discussed with reference to FIGS. 2 and 3A-3C.

At operation 420, the processing device determines a current failed bit count using results of the memory group scan. For example, memory group scan threshold determination component 113 determines a failed bit count for the memory group scan as the number of cells above the read voltage. Further details regarding determining a current failed bit count using results of the memory group scan are discussed with reference to FIGS. 2 and 3A-3C.

At operation 425, the processing device retrieves a second offset value using a second memory group. For example, memory group scan threshold determination component 113 retrieves a read voltage offset value for the memory group above or below the current memory group using a look-up table. Further details regarding retrieving a second offset value using a second memory group are discussed with reference to FIGS. 2 and 3A-3C.

At operation 430, the processing device performs a second memory group scan on the portion of memory using the second offset value. For example, memory group scan threshold determination component 113 performs a scan at a read voltage determined using the second offset value retrieved for the second memory group. Further details regarding performing a second memory group scan on the portion of memory using the second memory group are discussed with reference to FIGS. 2 and 3A-3C.

At operation 435, the processing device determines a second failed bit count using results of the second memory group scan. For example, memory group scan threshold determination component 113 determines a failed bit count for the memory group scan as the number of cells above the read voltage. Further details regarding determining a second failed bit count using results of the second memory group scan are discussed with reference to FIGS. 2 and 3A-3C.

At operation 440, the processing device allocates the portion of memory to a destination memory group using the current failed bit count, the second failed bit count, and the failed bit count threshold. For example, memory group scan threshold determination component 113 sets the memory group for the memory portion as a memory group that is not the current memory group in response to determining that the current failed bit count for the current memory group satisfies the failed bit count threshold. Further details regarding allocating the portion of memory to a memory group using the current failed bit count, the second failed bit count, and the failed bit count threshold are discussed with reference to FIGS. 2 and 3A-3C.

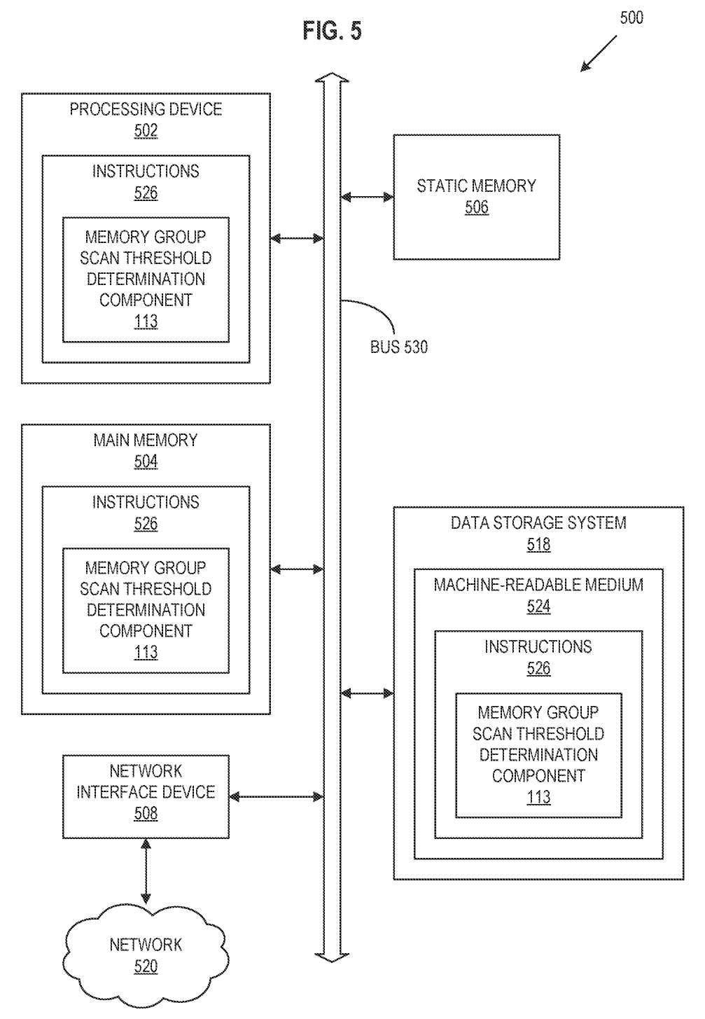

FIG. 5 illustrates an example machine of a computer system 500 within which a set of instructions for causing the machine to perform any one or more of the methodologies discussed herein can be executed. In some embodiments, the computer system 500 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the memory group scan threshold determination component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a smart device, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random-access memory (DRAM) such as synchronous DRAM (SDRAM) or Rambus DRAM (RDRAM), etc.), a static memory 506 (e.g., flash memory, static random-access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526, constituting machine-readable storage media, can also reside, completely or at least partially, within the main memory 504 and/or within the processing device 502 during execution thereof by the computer system 500, the main memory 504 and the processing device 502. The machine-readable storage medium 524, data storage system 518, and/or main memory 504 can correspond to the memory subsystem 10 of FIG. 1.

In one embodiment, the instructions 526 include instructions to implement functionality corresponding to a memory group scan threshold determination component (e.g., memory group scan threshold determination component 113 of FIG. 1). While the machine-readable storage medium 524 is shown in an example embodiment to be a single medium, the term “machine-readable storage medium” should be taken to include a single medium or multiple media that store the one or more sets of instructions (e.g., instructions 526). The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 200 and 300 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMs, EEPROMs, magnetic or optical cards, or any type of media suitable for storing electronic instructions coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
retrieving a failed bit count threshold of a plurality of failed bit count thresholds using a current memory group of a plurality of memory groups for a portion of memory;
retrieving a current offset value using the current memory group;
performing a memory group scan on the portion of memory using the current offset value;
determining a current failed bit count using results of the memory group scan;
retrieving a second offset value using a second memory group of the plurality of memory groups;
performing a second memory group scan on the portion of memory using the second offset value;
determining a second failed bit count using results of the second memory group scan; and
allocating the portion of memory to a destination memory group of the plurality of memory groups using the current failed bit count, the second failed bit count, and the failed bit count threshold, wherein the destination memory group is associated with a destination failed bit count threshold different than the failed bit count threshold for the current memory group.

2. The method of claim 1, further comprising:
determining that the current failed bit count satisfies the failed bit count threshold, wherein the second offset value is higher than the current offset value.

3. The method of claim 2, further comprising:
performing, in response to determining that the second failed bit count is greater than the current failed bit count, a third memory group scan on the portion of memory using a third offset value for a third memory group of the plurality of memory groups, wherein the third offset value is lower than the current offset value.

4. The method of claim 2, wherein allocating the portion of memory to the destination memory group comprises allocating the portion of memory to the second memory group in response to determining that the second failed bit count is not greater than the current failed bit count.

5. The method of claim 1, further comprising:
determining that the current failed bit count does not satisfy the failed bit count threshold, wherein the second offset value is lower than the current offset value.

6. The method of claim 5, wherein allocating the portion of memory to the destination memory group is in response to determining that the second failed bit count satisfies the failed bit count threshold.

7. The method of claim 6, further comprising:
performing a third memory group scan on the portion of memory using a third offset value for a third memory group of the plurality of memory groups, wherein the third offset value is lower than the second offset value;
determining a third failed bit count using results of the third memory group scan; and
comparing the second failed bit count to the third failed bit count, wherein allocating the portion of memory to the destination memory group is based on the comparison.

8. A non-transitory computer-readable storage medium comprising instructions that, when executed by a processing device, cause the processing device to:
retrieve a failed bit count threshold of a plurality of failed bit count thresholds using a current memory group of a plurality of memory groups for a portion of memory;
retrieve a current offset value using the current memory group;
perform a memory group scan on the portion of memory using the current offset value;
determine a current failed bit count using results of the memory group scan;
retrieve a second offset value using a second memory group of the plurality of memory groups;
perform a second memory group scan on the portion of memory using the second offset value;
determine a second failed bit count using results of the second memory group scan; and
allocate the portion of memory to a destination memory group of the plurality of memory groups using the current failed bit count, the second failed bit count, and the failed bit count threshold, wherein the destination memory group is associated with a destination failed bit count threshold different than the failed bit count threshold for the current memory group.

9. The non-transitory computer-readable storage medium of claim 8, wherein the processing device is further to:
determine that the current failed bit count satisfies the failed bit count threshold, wherein the second offset value is higher than the current offset value.

10. The non-transitory computer-readable storage medium of claim 9, wherein the processing device is further to:
perform, in response to determining that the second failed bit count is greater than the current failed bit count, a third memory group scan on the portion of memory using a third offset value for a third memory group of the plurality of memory groups, wherein the third offset value is lower than the current offset value.

11. The non-transitory computer-readable storage medium of claim 9, wherein allocating the portion of memory to the destination memory group comprises allocating the portion of memory to the second memory group in response to determining that the second failed bit count is not greater than the current failed bit count.

12. The non-transitory computer-readable storage medium of claim 8, wherein the processing device is further to:
determine that the current failed bit count does not satisfy the failed bit count threshold, wherein the second offset value is lower than the current offset value.

13. The non-transitory computer-readable storage medium of claim 12, wherein allocating the portion of memory to the destination memory group is in response to determining that the second failed bit count satisfies the failed bit count threshold.

14. The non-transitory computer-readable storage medium of claim 13, wherein the processing device is further to:
perform a third memory group scan on the portion of memory using a third offset value for a third memory group of the plurality of memory groups, wherein the third offset value is lower than the second offset value;
determine a third failed bit count using results of the third memory group scan; and
comparing the second failed bit count to the third failed bit count, wherein allocating the portion of memory to the destination memory group is based on the comparison.

15. A system comprising:
a plurality of memory devices; and
a processing device, operatively coupled with the plurality of memory devices, to:
retrieve a failed bit count threshold of a plurality of failed bit count thresholds using a current memory group of a plurality of memory groups for a portion of memory;
retrieve a current offset value using the current memory group;
perform a memory group scan on the portion of memory using the current offset value;
determine a current failed bit count using results of the memory group scan;
retrieve a second offset value using a second memory group of the plurality of memory groups;
perform a second memory group scan on the portion of memory using the second offset value, wherein the second offset value is different than the current offset value;
determine a second failed bit count using results of the second memory group scan;
perform a third memory group scan on the portion of memory using a third offset value for a third memory group of the plurality of memory groups; and
allocate the portion of memory to a destination memory group of the plurality of memory groups using the current failed bit count, the second failed bit count, and the failed bit count threshold, wherein the destination memory group is associated with a destination failed bit count threshold different than the failed bit count threshold for the current memory group.

16. The system of claim 15, wherein the processing device is further to:
determine that the current failed bit count satisfies the failed bit count threshold, wherein the second offset value is higher than the current offset value.

17. The system of claim 16, wherein performing the third memory group scan on the portion of memory is in response to determining that the second failed bit count is greater than the current failed bit count and wherein the third offset value is lower than the current offset value.

18. The system of claim 16, wherein allocating the portion of memory to the destination memory group comprises allocating the portion of memory to the second memory group in response to determining that the second failed bit count is not greater than the current failed bit count.

19. The system of claim 15, wherein the processing device is further to:
determine that the current failed bit count does not satisfy the failed bit count threshold, wherein the second offset value is lower than the current offset value.

20. The system of claim 15, wherein the processing device is further to:
determine a third failed bit count using results of the third memory group scan; and
comparing the second failed bit count to the third failed bit count, wherein allocating the portion of memory to the destination memory group is based on the comparison.
